(19) United States
(12) Patent Application Publication
(10) Pub. No.: US 2006/0078701 A1
(43) Pub. Date: Apr. 13, 2006

(54) System and method for manufacturing adhesive label-on-label arrays on tapes or strips

(76) Inventor: Fred Glasier, Elverson, PA (US)

Correspondence Address: Todd S. Parkhurst;30th Floor, 131 South Dearborn St,, Chicago, IL, 60603, US

(21) Appl. No.: 10/963,112

(22) Filed: Oct. 12, 2004

(51) Int. Cl. B32B 33/00

(52) U.S. Cl. 428/40.1

(57) ABSTRACT

A novel label-on-label array is disclosed which is adapted for use with medicine containers and like devices. The label array includes a bottom adhesive, a bottom label above the bottom adhesive, a top adhesive above a predetermined part of the bottom label, and a top label above the bottom label. Identical informational indicia are printed upon the top label and the bottom label. A doctor, nurse, or other individual can remove the top label from the bottom label and paste the top label on a patient's medical chart or other location so as to insure that information which appears on the patient's medical chart is identical with information appearing on the medicine container. A method of manufacturing the label array is also disclosed. The method comprises the steps of providing a carrier, bottom adhesive and bottom label; providing a flood coat of top adhesive and release agent to the top of the bottom label; and affixing the top label to the top adhesive in a predetermined position above the bottom label.

This invention relates to adhesive labels for pharmaceutical containers and like devices, and more particularly concerns multi-layer labels which permits an upper label to be removed from a lower label while the lower label remains affixed to the underlying container.

Current medical practice requires extreme care in dispensing particular medicines to particular patients. Good practice requires that the exact nature of the medicine, and even the medicine manufacturing batch number, be copied from the pharmaceutical container and recorded upon a patient's medical history or hospital chart. Recording errors can lead to extensive and expensive investigations and remediation efforts.

It is an object of this invention to provide a so-called label-on-label array or partially detachable label which permits a portion of the pharmaceutical container label to be simply and easily removed from underlying or adjacent parts of the label and the container surface, and then attached to the patient's chart or other patient information form, so that no manual label reading and information copying is required. The removed, relocated and reattached or pasted portion of the pharmaceutical container label carries information describing the pharmaceutical to be administered to the patient. Preferably, the information on the removed and relocated portion of the pharmaceutical label carries information identical to the information on that portion of the label which remains attached to the pharmaceutical container itself.

It is a related object of the invention to provide equipment for manufacturing and, if necessary, printing the label-on-label array inexpensively, reliably, and at high speed.

Other objects and advantages of the invention will become apparent upon reading the following detailed description and upon reference to the drawings. Throughout the drawings, like reference numerals refer to like parts.

### BRIEF DESCRIPTION OF THE DRAWINGS

FIG. 1 is a somewhat schematic drawing illustrating a label manufactured by the equipment suggested in FIG. 3.

FIG. 2 is a schematic drawing in cross-section taken substantially in the plane of line 2-2 in FIG. 1 showing the arrangement of principal parts of the label-on-label array manufactured by the equipment suggested in FIG. 3.

FIG. 3 is a schematic drawing suggesting principal parts of the manufacturing apparatus.

### DETAILED DESCRIPTION

While the invention will be described in connection with a preferred embodiment, it will be understood that it is not intended to limit the invention to this embodiment or procedure. On the contrary, it is intended to cover all alternatives, modifications and equivalents as may be included within the spirit and scope of the invention as defined by the appended claims.

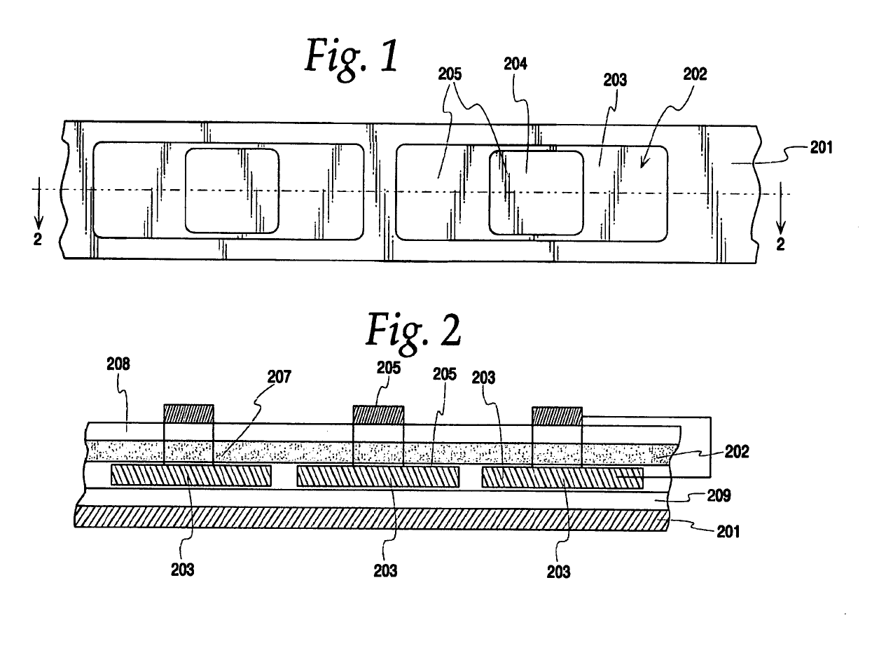

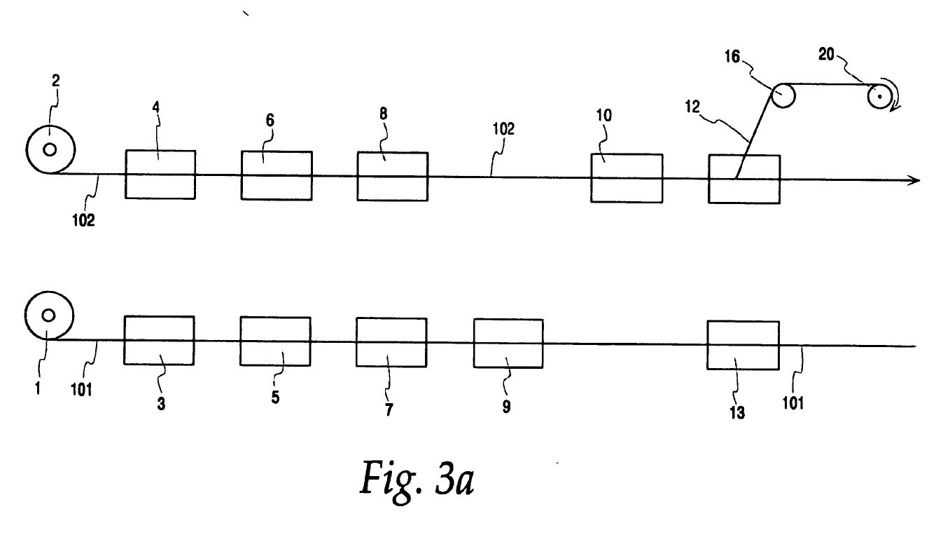

Turing first two FIGS. 1 and 2, there is shown an extended web or liner 201 of paper-like material having adhesively mounted upon it a label 202 embodying one aspect of the present invention. In general, this label 202 includes a lower or base label 203 adapted to be directly affixed to a pharmaceutical container of any suitable size and nature; and a detachable upper label 204 releasably affixed to the lower label 203. Identical information 205 may be imprinted or otherwise formed on the lower label 203 and upon the upper label 204. As particularly shown in FIG. 2, a release coating or matrix 207 is provided to keep the upper label 204 and adhesive 208 from too strongly engaging the top of the lower label 203.

In use, the entire label array 202 can be peeled from the underlying web liner or carrier substrate 201 and attached to a bottle or other container (not shown). It is contemplated that this container will contain medicine or other material which must be accurately identified both on the container to which the label 201 is affixed, and on a patient record or other separate location. To accomplish this, the upper label 204 bears printing 205 which is identical with printing 205 on the lower label 203. Accordingly, the doctor, nurse or other individual can simply peel the upper label 204 from the lower label 203 and affix the upper label 204 to the patient's medical chart, records, or other desired location. In that location, the upper label 204 will accurately identify the medicine in a manner that is identical with the identification of the medicine provided by the lower label 203 affixed to the medicine bottle or other container.

It will be understood that the various adhesives, label materials, label sizes, release coating and material treatments are selected so that the top label 204 will be peeled away from the underlying bottom label 203 without the bottom label 203 being disturbed or peeling away from the underlying container (not shown) to which it is affixed; that is, the bottom adhesive adheres more strongly to the container surface than the top adhesive adheres to the bottom label. This can be accomplished by properly selecting the proper formulations, amounts, arrangements and cores of adhesives and release coating.

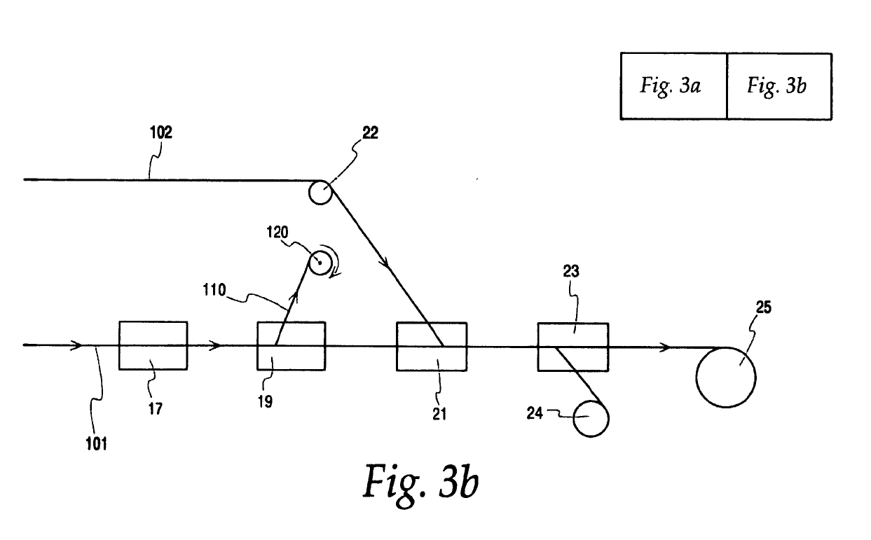

Methods of manufacturing these labels are suggested by the schematic illustration of FIGS. 3a and 3b. A feed roll 1 pays out an elongated web 101 comprising the underlying carrier or line 201, an adhesive 209 in continuous uniform layer configuration, and paper or other material comprising the lower label 203 (FIG. 2). Printing 205 may be pre-applied to the paper 203, or printing may be applied as described below. Simultaneously, an upper roll 2 pays out an elongated web 102 comprising a paper or other strip which will form the upper label 204. Printing 205 may be pre-applied to this upper label paper, or printing may be applied as described below.

Splicing equipment 3 and 4, sometimes known as splicer boxes, are provided immediately downstream of each payout roll 1 and 2, respectively, to permit the connection of the head end of a new web roll to be attached to the tail end of the preceding web so as to offer continuous production for any desired length of time. Festooners (not shown) or known design could be provided to facilitate splicing in a stationary mode while label production proceeds continously.

If desired, printing presses 5 and 6 of known design can print desired information on the lower and upper labels, respectively. Cure boxes 7 and 8 located immediately downstream of the printers 5 and 6 can be provided to set the printed ink and/or to alter the adherence characteristics of underlying label adhesives. For example, cure boxes 7 and 8 can provide a source of ultraviolet light to detackify previously applied adhesive, if desired.

Preferably, a unit 9 applies a continuous flood of release coating material 207 and, atop the release coat, a continuous layer of hot melt adhesive 208 to the top of the lower label web 203. The release coating 207 and adhesive 208 can be applied in a pattern or it can be applied as a continuous covering sometimes referred to as a flood coating. Flood coated release material, adhesive and top label waste in unwanted locations can subsequently stripped away at downstream stations.

A cutter station 10 is provided for cutting and for readying the top label 204 to be separated from surrounding paper material. Here the rotary die cutter cuts through the continuous web forming the top labels 204, and also cuts through the immediately underlying substrates of adhesive 208 and release coating 207. A punch roller and cooler station 13 can be provided for bottom web 101 processing to set ink and/or adhesive.

At a separator station, the cut matrix web 12 of paper, unneeded adhesive 208 and release coating 207 surrounding the top label is peeled away. The peeled matrix web 12 is routed, by any convenient roller 16 or other mechanisms, to a windup reel 20 for disposal or other processing.

Similarly, a die cutter station 17 cuts the bottom label to a desired shape, and excess surrounding paper and adhesive is peeled away at a separator station 19. This excess material 110 can be routed to a wind-up reel 120 for disposal. If desired, suitable mechanism (not shown) can be provided to introduce or mate the discard web 110 to the upper-level discard web 12 so that materials 110 and 12 can be wound up on the same reel, if desired.

At a mating station 21, the upper label web 102, the detachable labels 204, the underlying adhesive 208 and the release coating 202 is affixed to the main or lower label web 101. Again, suitable routing mechanism 22 can be provided to insure accurate registries at high web movement speeds.

If desired, a separator station 23 can be provided and arranged to permit the bottom carrier or liner to be peeled away and collected on a wind-up roll 24 for discard.

The completed label-on-label products are routed to a final windup roll 25 for shipment and use by customers.

It will be understood that multiple lines or strings of labels can be manufactured as disclosed here, and these multiple side-by-side strings of labels can be slit or otherwise separated into single-string rolls for shipment and subsequent use by customers.

It will also be understood that suitable rollers, drums, and other equipment not shown here can be employed to reverse or otherwise alter the direction of travel of the upper and lower label webs so as to conserve production floor space and obtain other conveniences and economics

We claim:

1. A label array for a container, comprising, in combination,
a bottom adhesive for attaching the label array to a surface,
a bottom label above and engaged with the bottom adhesive,
a top adhesive upon and engaged with a predetermined portion of the bottom label, and
a top label located above the bottom label and engaged with the top adhesive.

2. A label array according to claim 1 further including informational indicia on the bottom label and on the top label.

3. A label array according to claim 2 wherein said informational indicia on the bottom label is located in a place not covered by the top label.

4. A label array according to claim 2 wherein at least some of the informational indicia on the bottom label is identical with at least some of the informational indicial on the top label.

5. A label array according to claim 1 further including a release coating between the bottom label and the top adhesive.

6. A method of making a label array, comprising the steps of providing a carrier, a bottom adhesive, a bottom label and a top label, and affixing a top label, release coating and top adhesive in a predetermined position to the bottom label

7. A method according to claim 6 further including the step of removing those portions of release coating and top adhesive which are not covered by the top label.

8. A method according to claim 6 further including the step of printing informational indicia on the bottom label.

7. A method according to claim 6 further including the step of printing informational indicia on the bottom label, and printing informational indicia on the top label which is at least in part identical with the informational indicia printed on the bottom label.

8. A method according to claim 6 further including the step of treating at least one of the adhesives after it has been applied so as to alter the adhesive characteristics.

9. A method according to claim 10 wherein said treating step includes the step of treating the adhesive with ultraviolet light.

10. A method according to claim 6 including the steps of peeling the carrier from the bottom carrier and combining the removed mask with the peeled carrier for common disposal.
